(19) United States
(12) Patent Application Publication
(10) Pub. No.: US 2021/0352871 A1
(43) Pub. Date: Nov. 18, 2021

(54) PORTABLE PET CLEANING AND CARE SALON

(71) Applicant: Viola L Freeman, Lawrenceville, GA (US)

(72) Inventor: Viola L Freeman, Lawrenceville, GA (US)

(21) Appl. No.: 16/876,805

(22) Filed: May 18, 2020

(51) Int. Cl. A01K 13/00; A01K 15/04

(52) U.S. Cl. CPC A01K 13/001; A01K 15/04

(57) ABSTRACT

The disclosed system and method includes a pet enclosure to facilitate easy pet washing and care. The enclosure includes circular openings to comfortably secure pets' heads, openings for hand access to pet, and grated, non-slip flooring for pet comfort. The enclosure includes tools for ease of washing including water and shampoo spraying hoses, hose holders, openings for blow dryers, valves to control water on/off and temperature control, an inline shampoo compartment, and a door for pet entry/exit. The system also includes restraints of pet movement inside the enclosure for an added measure of pet comfort. The enclosure also includes two attachments, the shampoo compartment and a shampoo hose connector. Handles on top of the enclosure make it easy to transport.

### BACKGROUND OF THE INVENTION

### Field of Invention

The present invention relates to a device used to secure an animal pet comfortably for ease of washing, cleaning, and grooming.

### Description of Related Art

Over half of households in America own a pet or pets. According to a National Pet Owners Survey conducted by the American Pet Products Association (APPA), the percent of U.S. households that own a pet or pets is sixty-seven percent, or about 85 million families. As can be deduced by the number of pet owners, pet care products and services are a real and large part of the retail market. Pet owners buy pet products and services such as food, treats, toys, medicine, medical care, vitamins, grooming/grooming help, kennel boarding or other temporary pet care, and insurance.

A large concern for pet owners is hygiene and cleanliness. Cleanliness benefits both the pet and the owner. To tailor to this need, many pet stores, vets, and pet hospitals also offer pet grooming and pet washing. This makes cleanliness easy for the owner who would otherwise have the hassle of finding a space and tools to wash the pet then only to start washing their pet and struggle to also keep the pet still and comfortable. Such locations also offer special products like pet shampoo, pet conditioner, pet soap, and others that contain treatments for anti-lice, anti-tick etc., or formulas with special sensitivity to the pet's skin.

### BRIEF DESCRIPTION OF DRAWINGS

FIG. 1 depicts an acrylic pet enclosure with restraints and attached washing tools and openings for hand contact in accordance with an embodiment of the present disclosure.

FIG. 2 depicts an attachment hose for the acrylic pet enclosure washing tools in accordance with an embodiment of the present disclosure.

FIG. 3 depicts a method for washing a pet in an enclosure with restraints including tools and slots for hand contact in accordance with an embodiment of the present disclosure.

Throughout the description, same and similar reference numbers may be used to identify same and similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

The present disclosure is an acrylic pet enclosure that secures the pet comfortably via restraints attached and tools and openings to facilitate pet washing via a rubber attachment to a house faucet and a T connection for mixing detergent into a wash water.

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, the term ‘enclosure’ refers to a box shaped space large enough for a household pet to comfortably be washed inside. The term ‘plumbing network’ refers to a grid of piping engineered to distribute a wash water and a rinse water inside the enclosure to wash the pet from head to toe and from top to bottom, literally.

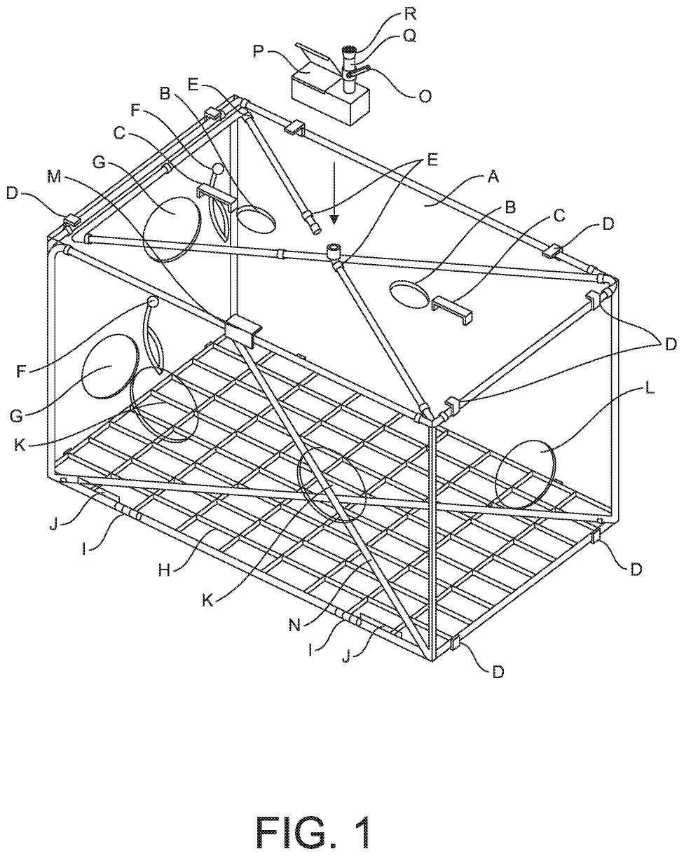

FIG. 1 depicts an acrylic pet enclosure with washing tools and slots for hand contact in accordance with an embodiment of the present disclosure. The enclosure is a 6 sided box made of 5 clear acrylic ¼″ thick panels A and one removable grated flooring H where clamps D hold the panels together.

One acrylic panel is connected to the grated flooring H by two hinges I on the edge of the connecting panel. Clear hoses with holes to spray water and shampoo N cross each other over the grated flooring H and connect to the shampoo box P. This makes the panel act as a door where pets may enter and exit the enclosure. There are two slits for water drainage J near the hinges I in the same acrylic panel. A Latch M secures the panel to the rest of the enclosure, opening or closing the door. There are two circle openings K spaced evenly apart in the center of this panel allowing for hand access to the pet while pet is inside the enclosure.

The top panel includes two openings for blow dryers B, two handles C for carrying the enclosure, U-shaped hose holders E, and two leashes F attached to the top panel and extending into the inside of the enclosure to secure pets in place.

A side panel has two circular openings G for pet head to extend out of the enclosure. Another side panel has one circular opening allowing for hand access to administer care to pet rectal area L. Another side panel has no openings or additional features. Additional clamps D hold these panels to the others.

An attachable detachable piece is comprised of a shampoo compartment with clamp on lid P, connection to hose R, clear hose Q, and a valve to turn water on and off and control temperature O.

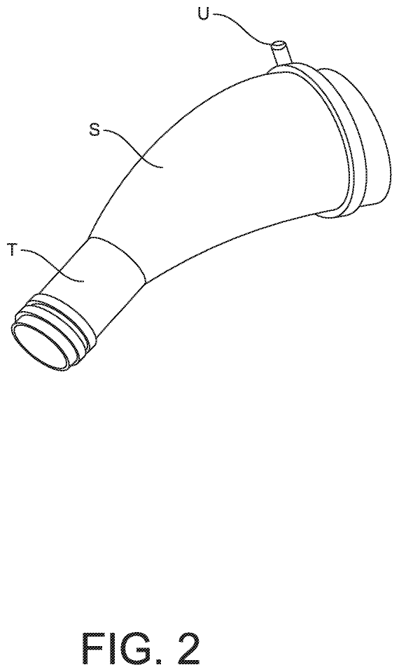

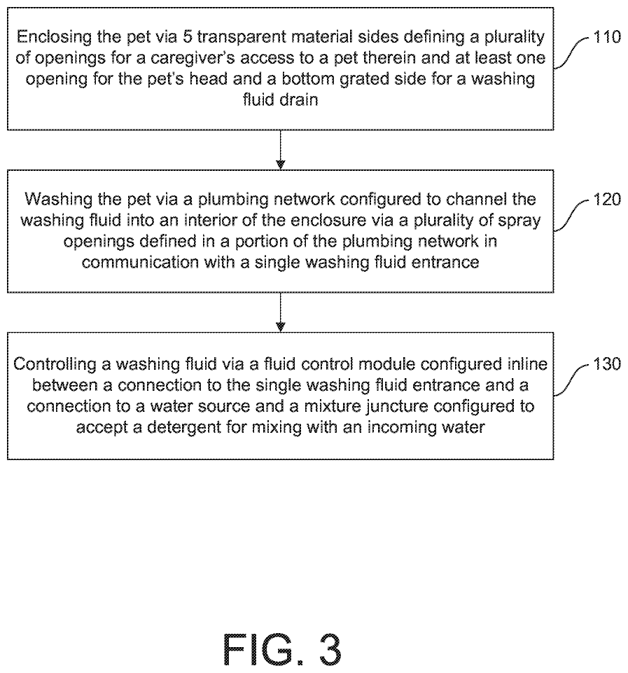

FIG. 2 depicts an attachment hose in accordance with an embodiment of the present disclosure. The attachment hose having one side of the hose connecting to shampoo box T, a rubber spout cover S, and a clamp U to hold cover S in place. The clamp is depressed to allow fitting to a household faucet and relaxed to securely form a connection thereto. FIG. 3 depicts a method for washing a pet in an enclosure with restraints including tools and slots for hand contact in accordance with an embodiment of the present disclosure. The method includes enclosing 110 the pet via 5 transparent material sides defining a plurality of openings for a caregiver's access to a pet therein and at least one opening for the pet's head and a bottom grated side for a washing fluid drain. The method also includes washing 120 the pet via a plumbing network configured to channel the washing fluid into an interior of the enclosure via a plurality of spray openings defined in a portion of the plumbing network in communication with a single washing fluid entrance. The method further includes controlling 130 a washing fluid via a fluid control module configured inline between a connection to the single washing fluid entrance and a connection to a water source and a mixture juncture configured to accept a detergent for mixing with an incoming water.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A system for washing a pet, the system comprising:
a. an enclosure comprising 5 transparent material sides defining a plurality of openings for a caregiver's access to a pet therein and at least one opening for the pet's head and a bottom grated side for a washing fluid drain;
b. a washing plumbing network configured to channel the washing fluid into an interior of the enclosure via a plurality of spray openings defined in a portion of the plumbing network in communication with a single washing fluid entrance; and
c. a washing fluid control module configured inline between a connection to the single washing fluid entrance and a connection to a water source and a mixture juncture configured to accept a detergent for mixing with an incoming water.

2. The system of claim 1, wherein the washing fluid control module comprises an inline water flow rate valve and an inline water temperature control valve.

3. The system of claim 1, wherein the plurality of openings for a caregiver's access include openings for a blow dryer forced air into the enclosure to dry the pet.

4. The system of claim 1, wherein the plurality of openings for a caregiver's access include an opening for access to a pet's rectal area by the caregiver.

5. The system of claim 1, wherein the plurality of openings for a caregiver's access include a plurality of openings for a caregiver's hands to enter the enclosure to handle the pet.

6. The system of claim 1, further comprising a plurality of loop restraints attached to the enclosure at one end thereof and a second free end configured to an appendage of the pet.

7. The system of claim 1, further comprising a plurality of leashes attached to the enclosure at one end thereof and a second free end configured to attach to a pet collar.

8. The system of claim 1, further comprising a rinsing plumbing network configured to channel a rinsing fluid into an interior of the enclosure via a plurality of spray openings defined in a portion of the rinsing plumbing network in communication with a single rinsing fluid entrance.

9. The system of claim 1, wherein the washing plumbing network is configured in an “X” configuration in a plane adjacent a top side of the enclosure.

10. The system of claim 1, wherein the washing plumbing network is configured in a first “X” configuration in a plane adjacent a top side of the enclosure and a second “X” configuration in a plane adjacent the bottom grated side of the enclosure.

11. The system of claim 1, wherein the 5 transparent sides are adjoined via a plurality of metallic clamps configured to loosely attach the 5 transparent sides into a box shape.

12. The system of claim 1, further comprising one of the 5 transparent sides configured to open at a top edge on a hinge side on a bottom edge.

13. The system of claim 1, further comprising a plurality if slits defined in at least one side of the 5 transparent sides, the plurality of slits configured to allow air and water to enter and to exit the enclosure.

14. The system of claim 1, wherein the washing plumbing network is attached to an inside of the enclosure via a plurality of “U” shaped holders.

15. The system of claim 1, wherein the bottom grated side comprises a lattice work opening ratio to a cross member thickness of less than one.

16. A method for washing a pet, the method comprising:
a. enclosing the pet via 5 transparent material sides defining a plurality of openings for a caregiver's access to a pet therein and at least one opening for the pet's head and a bottom grated side for a washing fluid drain;
b. washing the pet via a plumbing network configured to channel the washing fluid into an interior of the enclosure via a plurality of spray openings defined in a portion of the plumbing network in communication with a single washing fluid entrance; and
c. controlling a washing fluid via a fluid control module configured inline between a connection to the single washing fluid entrance and a connection to a water source and a mixture juncture configured to accept a detergent for mixing with an incoming water.

17. The method of claim 16, further comprising controlling an inline water flow rate via a valve and controlling an inline water temperature control via a valve.

18. The method of claim 16, further comprising rinsing the washing fluid from the pet via a rinsing plumbing network configured to channel a rinsing fluid into an interior of the enclosure via a plurality of spray openings defined in a portion of the rinsing plumbing network in communication with a single rinsing fluid entrance

19. The method of claim 16, further comprising restraining a movement of the pet by extending the pet's head through an opening in a front side of the enclosure and tethering the pet via a leash attached to the enclosure.

20. The method of claim 16, further comprising drying the pet by a forced hot air directed through a plurality of openings defined in at least one of the 5 sides of the enclosure.
